(19) United States
(12) Patent Application Publication
(10) Pub. No.: US 2012/0024163 A1
(43) Pub. Date: Feb. 2, 2012

(54) RING-SHAPED ADAPTER HAVING A NET FOR BREWING TEA IN DISPOSABLE CUPS

(76) Inventor: Kai Sauerwein, Frankfurt am Main (DE)

(21) Appl. No.: 13/096,927

(22) Filed: Apr. 28, 2011

(30) Foreign Application Priority Data
Jul. 30, 2010 (DE) 20 2010 010 872.1
Dec. 18, 2010 (DE) 10 2010 055 096.5

(51) Int. Cl. A47J 31/06

(52) U.S. Cl. 99/317

(57) ABSTRACT

A ring-shaped adapter that is capable of connecting a standardized disposable cup with a standardized disposable lid, being separable from said cup and said lid, includes a net that can be placed inside the disposable cup and is suitable for accommodating tea leaves.

### CROSS-REFERENCES TO RELATED APPLICATIONS

This application claims priority from German Application Nos. 20 2010 010 872.1, filed Jul. 30, 2010, and 10 2010 055 096.5, filed Dec. 18, 2010, the disclosures of which are incorporated by reference herein in their entirety.

### BACKGROUND

In the catering industry, the dispensing of tea for takeout takes place by using standardized disposable cups, which are filled with hot water and a tea bag. This form of dispensing provides for only a limited tea enjoyment, because, on the one hand, only water and a teabag are sold instead of tea, which is brewed with the tea bag, and because, on the other hand, the tea bag must be removed again from the cup in an awkward manner using the fingers to avoid over-bittering.

This thus leads to the problem of providing an opportunity for the buyer of tea from a catering operation using existing standard disposable cups and standard disposable lids, to sell tea, which is brewed in a tea net, for takeout and to make it possible for the buyer at the same time, to remove the tea bag again in a simple manner after finishing the brewing.

Systems, which facilitate the use of tea bags in takeout catering by using a special lid, already exist. However, these solutions do not provide for the use of a tea net, which is more suitable for the brewing of tea than a tea bag.

In addition, the available standard lids cannot be used further when using a special lid.

### SUMMARY

An object of the invention is to provide a ring-shaped adapter, which is provided with a net, for connecting standard disposable cups to standard disposable lids so as to be capable of being separated.

### DESCRIPTION OF THE DRAWINGS

An exemplary embodiment is illustrated in the drawings and will be described below:

FIG. 1 shows a side view of a standard lid;

FIG. 2 shows a side view of a ring-shaped adapter;

FIG. 3 shows a top view of a standard cup; and

FIG. 4 shows a top view of a ring-shaped adapter.

### DETAILED DESCRIPTION

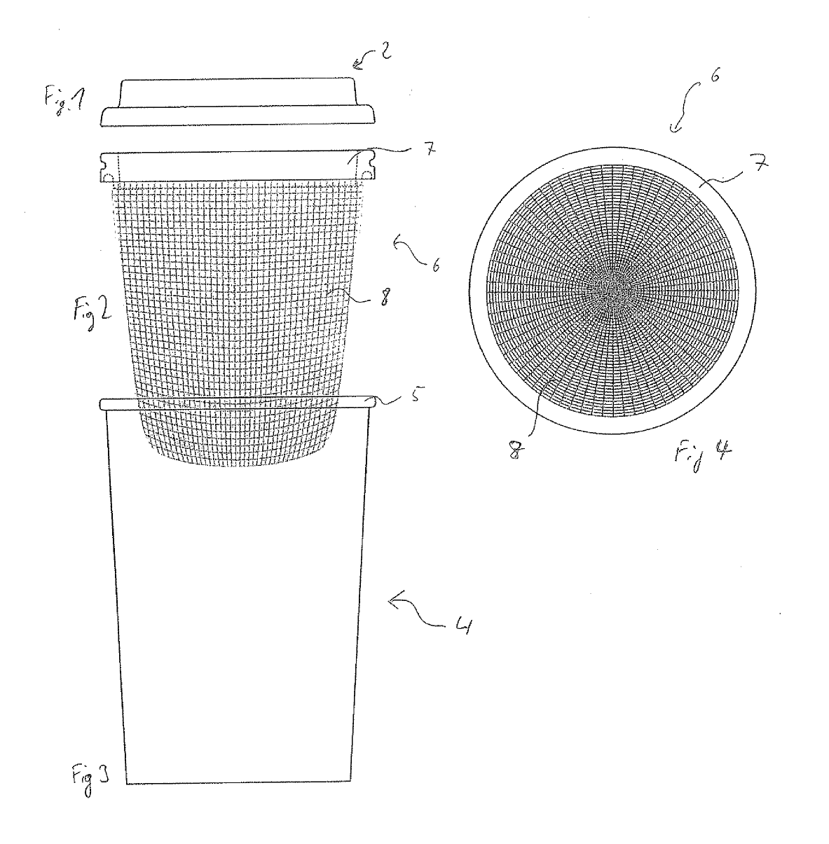

FIG. 1 shows a standard lid 2 which is used with a standard disposable cup 4 as shown in FIG. 3. The lid 2 defines a ring-shaped opening, wherein the dimension of the opening is adapted to receive an upper rim 5 of the standard cup 4.

FIG. 2 shows a ring-shaped adapter 6 having a rim 7, which is designed to be disposed between the lid and the upper rim 5 of the cup 4. Moreover, the ring-shaped adapter includes a net 8 which is circumferentially connected to the inner sidewall of the ring-shaped rim 7 of the adapter as shown in FIG. 4. The net 8 is designed to accommodate tea leaves inside.

In use, the net 8 of the ring-shaped adapter 6 can be filled with tea leaves and infused in hot water contained in the cup. The cup, including the ring-shaped adapter, may be closed by the lid 2. After a desired time period, the ring-shaped adapter 6, including the net 8 and the tea leaves, may be removed from the cup and the cup 4 may be closed by the same lid 2 as used before on the top of the adapter 6.

1. A ring-shaped adapter configured to connect a standardized disposable cup with a standardized disposable lid being separable from said cup and said lid, wherein said ring-shaped adapter includes a net that is configured to be disposed within the disposable cup and is suitable for accommodating tea leaves.

2. The ring-shaped adapter of claim 1, wherein the net is circumferentially attached to an inner sidewall of a rim of the ring-shaped adapter.

3. A kit including a disposable cup, a disposable lid adapted to close the cup, and a ring-shaped adapter of claim 1 adapted to be disposed between the lid and the cup with the net inside the disposable cup.
